(19) United States
(12) Patent Application Publication
(10) Pub. No.: US 2015/0293623 A1
(43) Pub. Date: Oct. 15, 2015

(54) TOUCH INTERACTION APPARATUS AND ELECTRONIC DEVICE HAVING THE SAME

(71) Applicant: SAMSUNG ELECTRO-MECHANICS CO., LTD., Suwon (KR)

(72) Inventors: Ho Jun KIM, Suwon (KR); Hee Bum LEE, Suwon (KR); Mi Jin CHOI, Suwon (KR); Hyun Ho LIM, Suwon (KR)

(73) Assignee: SAMSUNG ELECTRO-MECHANICS CO., LTD., Suwon (KR)

(21) Appl. No.: 14/462,851

(22) Filed: Aug. 19, 2014

(30) Foreign Application Priority Data
Apr. 9, 2014 (KR) 10-2014-0042488

(51) Int. Cl. G06F 3/044

(52) U.S. Cl. CPC G06F 3/044

(57) ABSTRACT

A touch interaction apparatus may be capable of providing preset different images by one key according to a degree of touch interaction. The touch interaction apparatus may include: an input unit having a plurality of keys formed in preset touch regions and receiving a user's touch interaction in a corresponding touch region of each of the plurality of keys; and a controlling unit outputting one of a plurality of images associated with a corresponding key according to a degree of touch interaction input to a touch region corresponding to a key of the input unit.

### CROSS-REFERENCE TO RELATED APPLICATION

This application claims the benefit of Korean Patent Application No. 10-2014-0042488 filed on Apr. 9, 2014, with the Korean Intellectual Property Office, the disclosure of which is incorporated herein by reference.

### BACKGROUND

The present disclosure relates to a touch interaction apparatus and an electronic device having the same.

A user interface, a device element allowing a user to interact with a device by inputting data thereto and selecting functions thereof, has been developed.

A representative example of a user interface is a keyboard, a device having limitations due to number of keys capable of being physically installed therein being limited due to limits on keyboard sizes and the number of human fingers.

Meanwhile, in the case in which the keyboard is displayed on a screen by an application of a smartphone or a tablet PC, or the keyboard is installed in a relatively small space such as a cover of the smartphone, a cover of the tablet PC, or the like, the number of keys should be significantly reduced, and even in the case in which only interacts with such a keyboard using one or two fingers, efficiency of the input requiring a multi-touch such as a shift key, a function key, or the like, may be degraded.

The following related art documents propose keyboards for providing various functions using single keys or programs therefor, but do not disclose technical contents capable of providing various functions by one key according to a degree of a touch interaction.

### RELATED ART DOCUMENT

(Patent Document 1) Korean Patent Laid-Open Publication No. 2011-0085523

(Patent Document 2) Japanese Patent Laid-Open Publication No. 2005-032207

### SUMMARY

An exemplary embodiment in the present disclosure may provide a touch interaction apparatus capable of providing preset different images by one key according to a degree of touch interaction, and an electronic device having the same.

According to an exemplary embodiment in the present disclosure, a touch interaction apparatus and an electronic device having the same may include: an input unit having a plurality of keys formed in preset touch regions and receiving a user's touch interaction in a corresponding touch region of each of the plurality of keys; and a controlling unit outputting one of a plurality of images associated with a corresponding key according to a degree of touch interaction with a touch region corresponding to a key of the input unit.

The touch interaction apparatus and the electronic device having the same may output one of the plurality of images according to capacitance or pressure varied by the degree of touch interaction pressure, and output one of the plurality of images according to the degree of touch interaction pressure to a corresponding touch region corresponding to one key.

The touch interaction apparatus and the electronic device having the same may output an image from a from a group of images including at least one group of an upper case and lower case character function, a number and symbol function, a soft consonant, hard consonant, and aspirated consonant function, a monophthong and diphthong function, a cursor movement by a space bar and a tab key, cursor movements in up, down, left, and right directions, a function of a plurality of special characters, and a function of a plurality of function keys, according to the degree of touch interaction input to the corresponding touch region corresponding to one key.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic configuration diagram of a touch interaction apparatus according to an exemplary embodiment in the present disclosure;

FIG. 2 is a configuration diagram of an electronic device coupled to the touch interaction apparatus according to an exemplary embodiment in the present disclosure;

FIG. 3 is a schematic top view and a schematic perspective view of the electronic device according to an exemplary embodiment in the present disclosure;

FIG. 4 is a graph showing a relationship between touch interaction pressure and a resistance; and

FIGS. 5A through 5L and FIGS. 6A through 6L are views showing examples of the touch interaction apparatus according to an exemplary embodiment in the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements may be exaggerated for clarity, and the same reference numerals will be used throughout to designate the same or like elements.

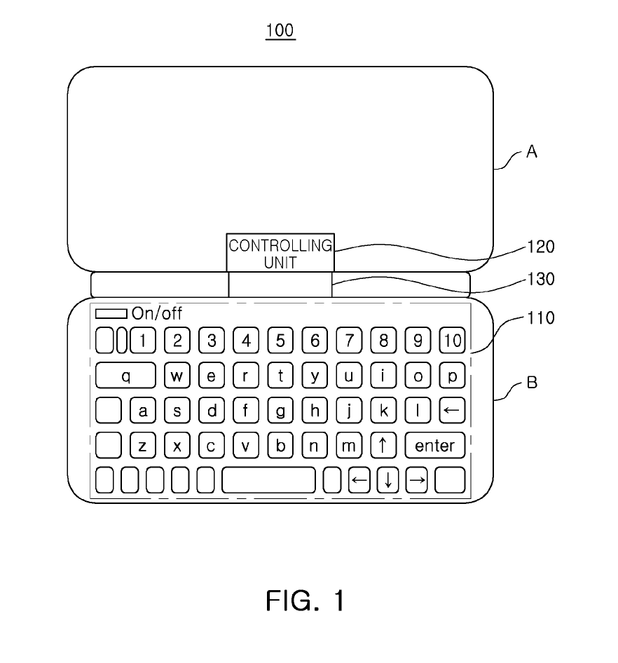

FIG. 1 is a schematic configuration diagram of a touch interaction apparatus according to an exemplary embodiment in the present disclosure.

Referring to FIG. 1, a touch interaction apparatus 100 according to an exemplary embodiment in the present disclosure may include an input unit 110 and a controlling unit 120.

The touch interaction apparatus 100 may include the input unit 110 having a touch region and the controlling unit 120 controlling a preset operation according to a degree of touch interaction of a user input from the input unit 110.

For example, the touch interaction apparatus 100 may be configured as a cover of a smartphone, a cover of a tablet PC, or the like, and such covers include both surfaces A and B having a predetermined area, where one surface B may be provided with the input unit 110 and the one surface B or the other surface A may be provided with the controlling unit 120. In the case in which the other surface A is provided with the controlling unit 120, a connecting unit 130 for transferring information input to the input unit 110 to the controlling unit 120 may be added.

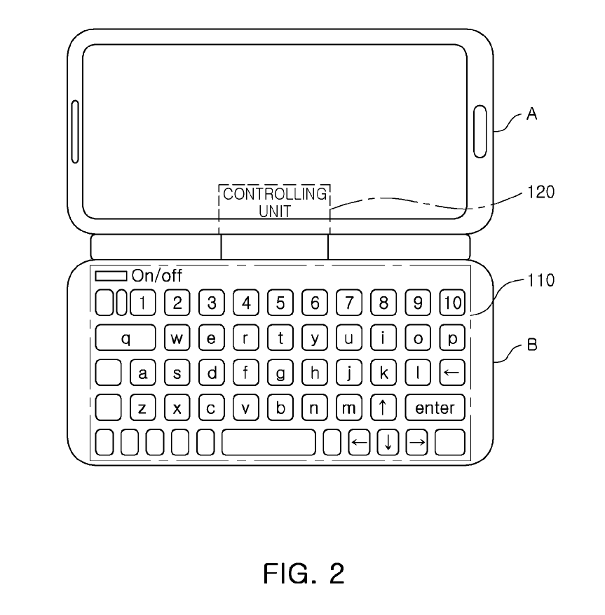

FIG. 2 is a configuration diagram of an electronic device coupled to the touch interaction apparatus according to an exemplary embodiment in the present disclosure.

As illustrated in FIG. 2, an electronic device 200 may be attached to the other surface A by a variety of fixing apparatuses, and the electronic device 200 and the controlling unit 120 may be electrically connected to each other, such that a corresponding operation may be displayed on a display unit of the electronic device 200 according to the degree of touch interaction of the user's interaction with the input unit 110.

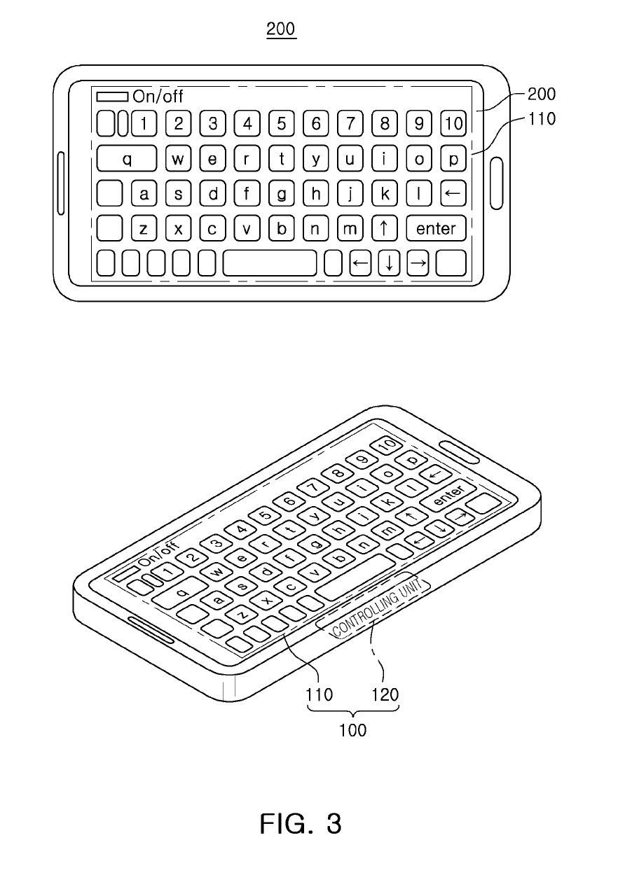

FIG. 3 is a schematic top view and a schematic perspective view of the electronic device according to an exemplary embodiment in the present disclosure.

Meanwhile, referring to FIG. 3, the touch interaction apparatus 100 may be implemented in the electronic device 200.

The input unit 110 may be implemented on a display unit 210 of the electronic device 200 and the controlling unit 120 may be implemented within the electronic device 200.

For example, the electronic device 200 may be a portable terminal such as a smartphone or a tablet PC and the input unit 110 may be a keyboard program displayed on the display unit 210 of the portable terminal such as the smartphone or the tablet PC. In this case, the display unit 210 may be a touch screen capable of having a user's touch interaction applied thereto and displaying a corresponding image.

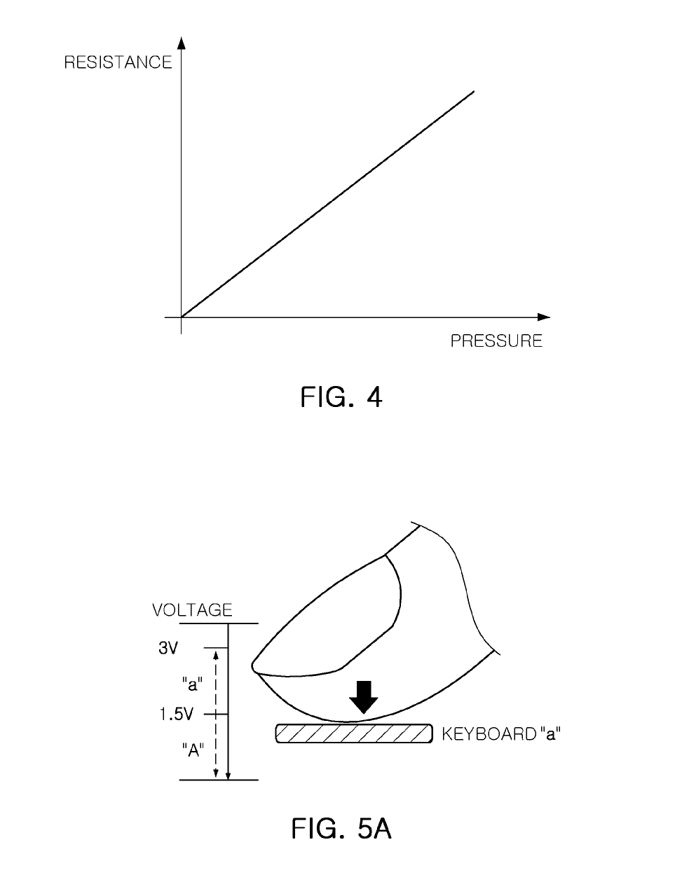

FIG. 4 is a graph showing a relationship between touch interaction pressure and resistance.

Referring to FIG. 4, in the case in which the touch interaction apparatus according to an exemplary embodiment of the present disclosure or the electronic device having the same has the user's touch interaction applied thereto, it may perform a corresponding operation according to a degree of touch interaction pressure. In this case, a touch pad, a touch screen, or the like used in the touch interaction apparatus according to an exemplary embodiment of the present disclosure or the electronic device having the same may have a direction proportion established between touch pressure and resistance as illustrated in FIG. 4, whereby it may distinguish the degree of touch interaction to thereby differently perform the corresponding operation.

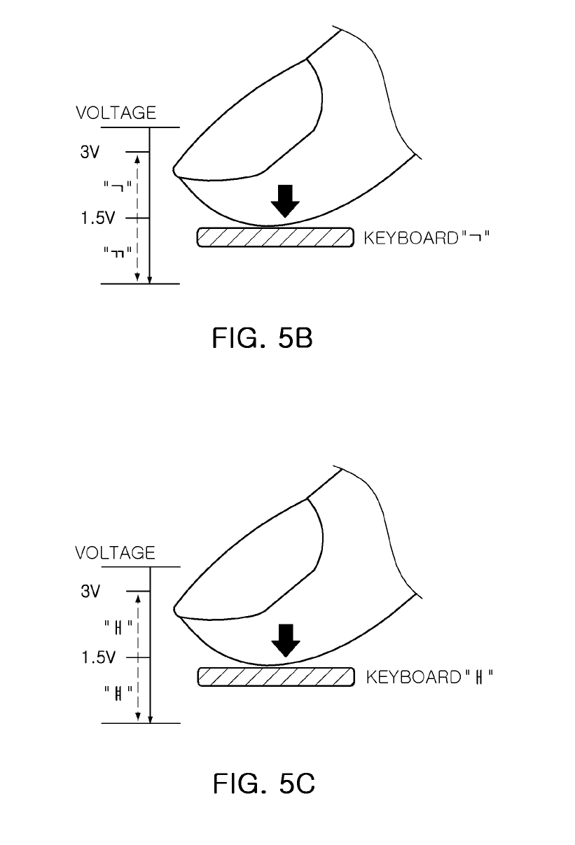

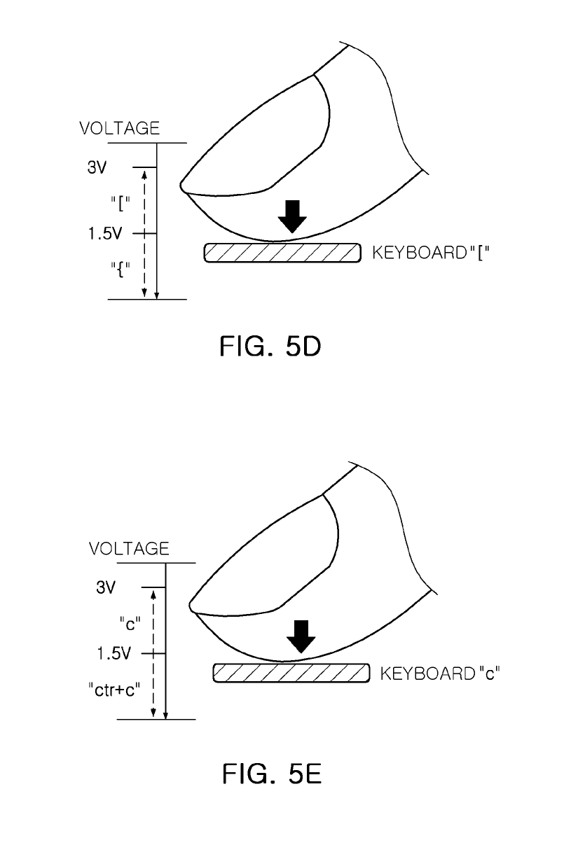

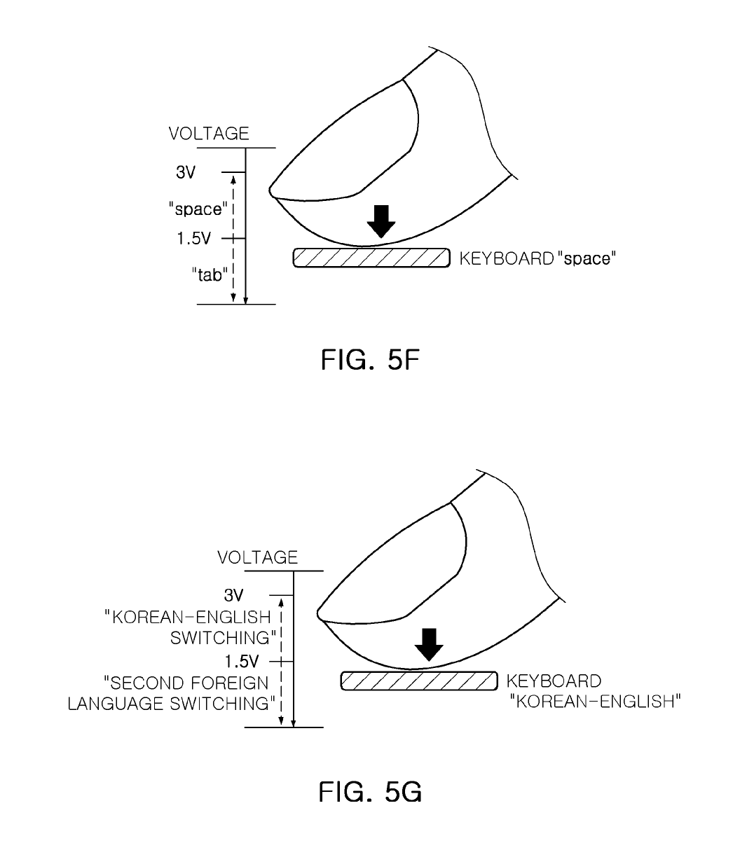

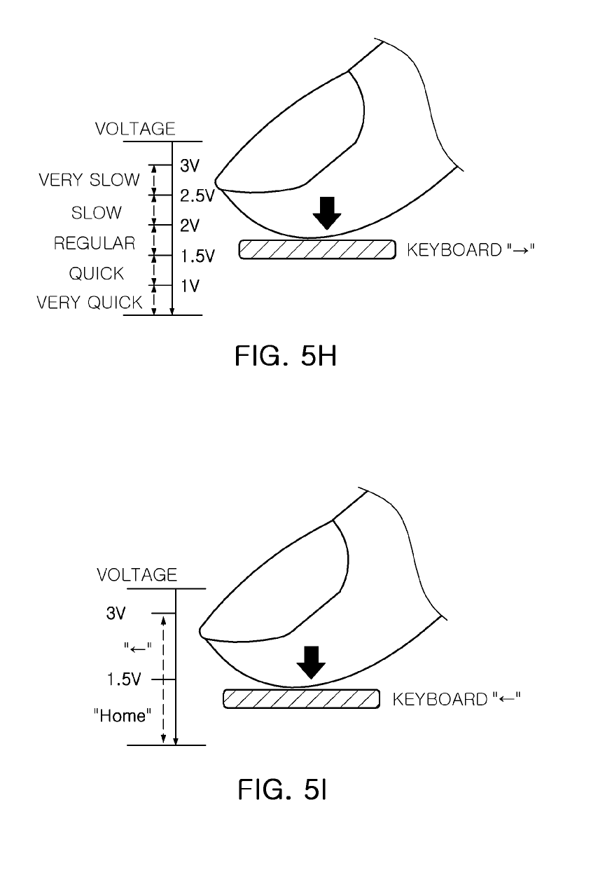

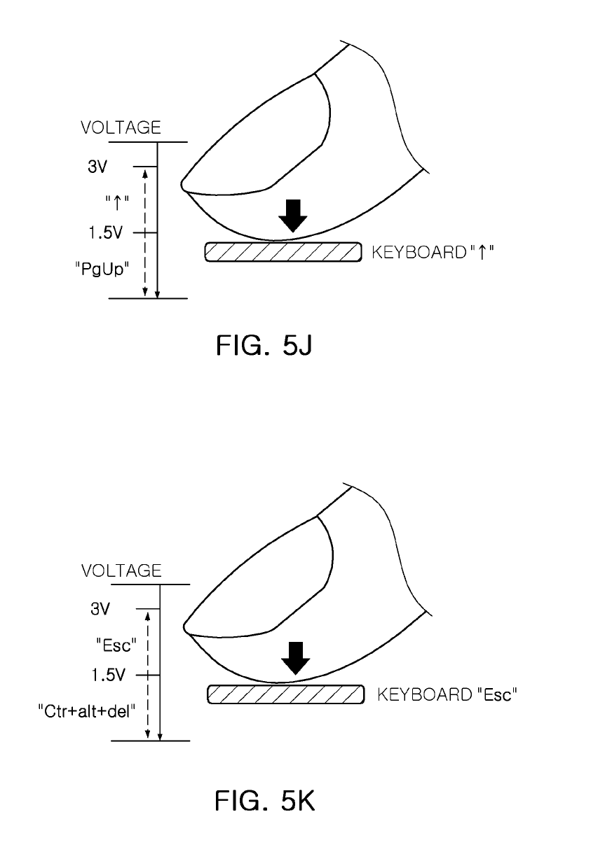

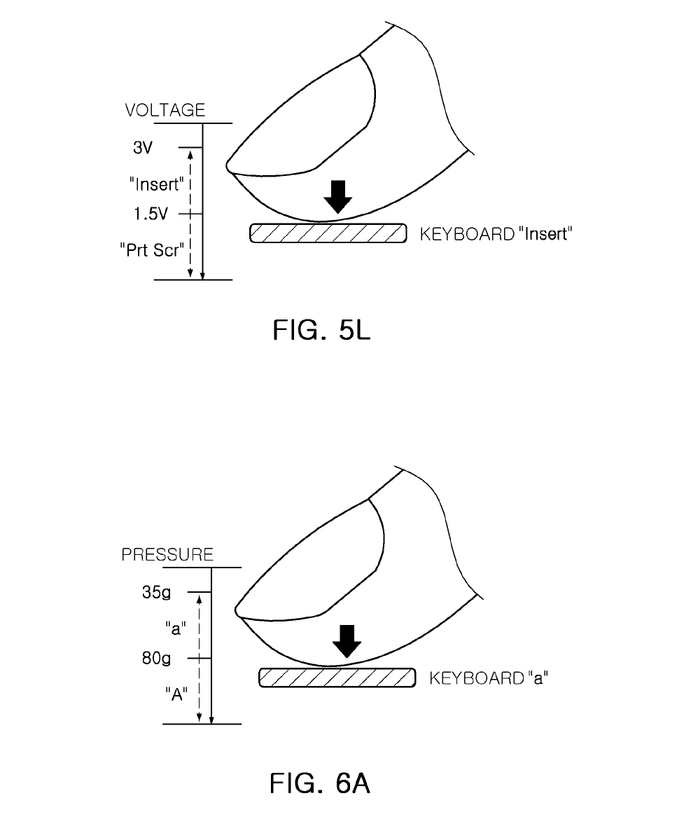

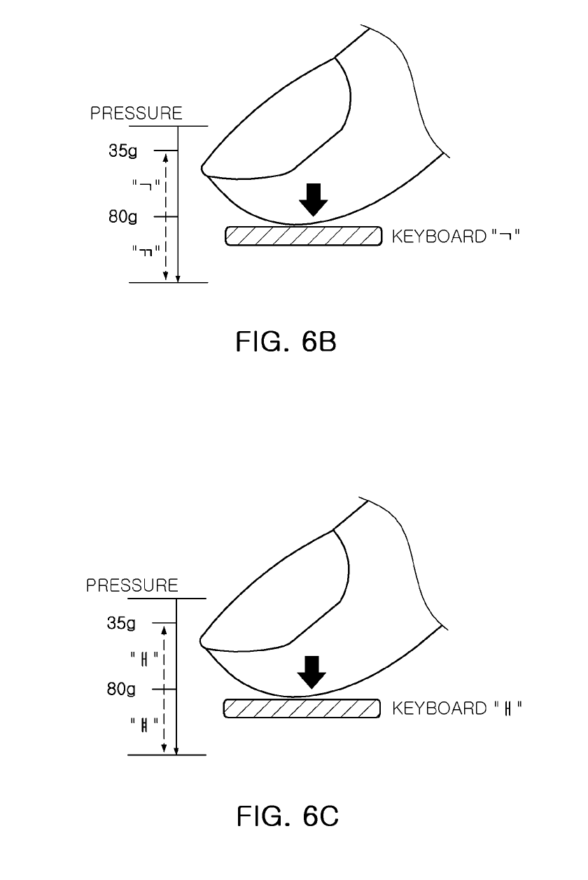

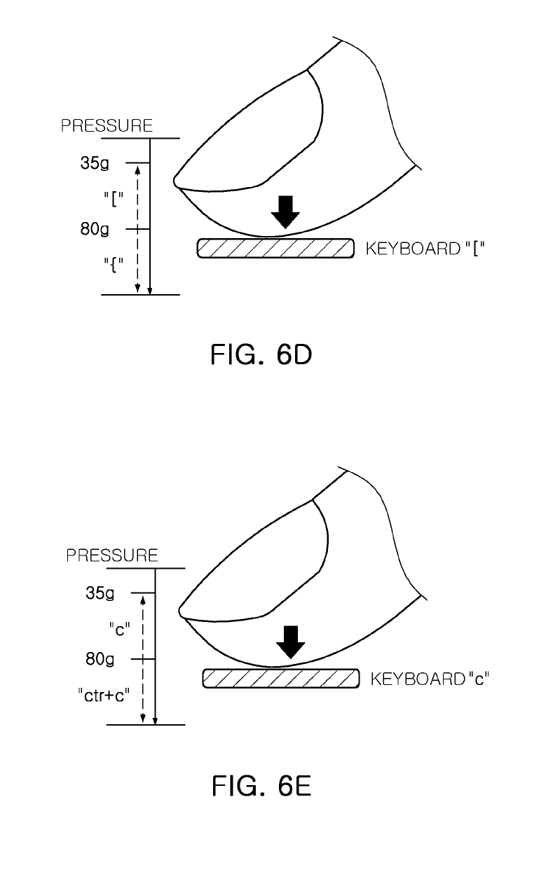

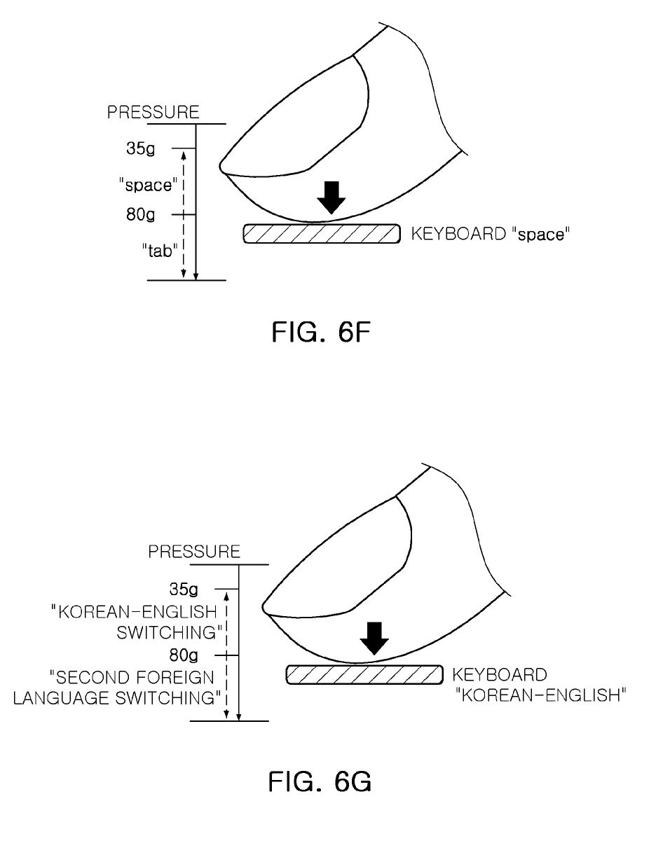

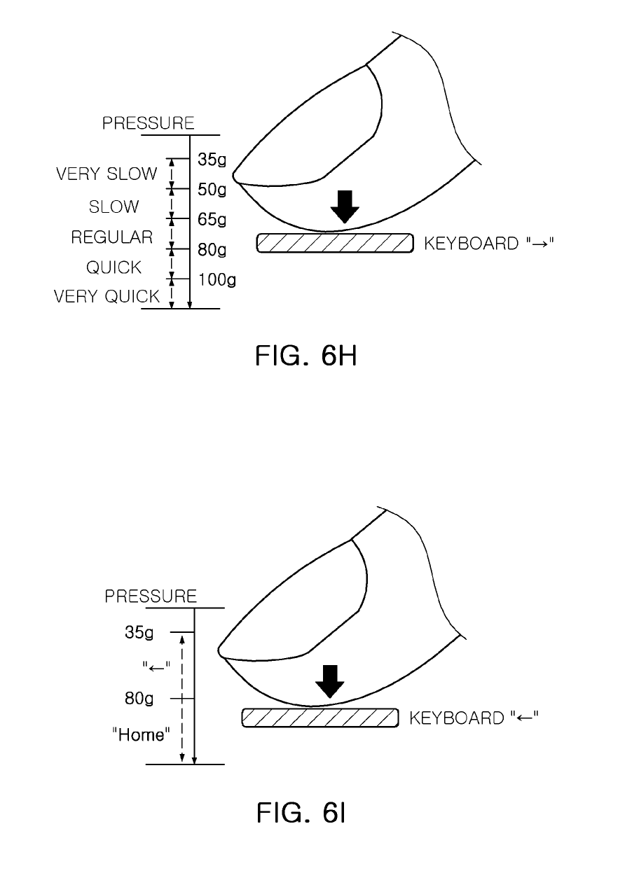

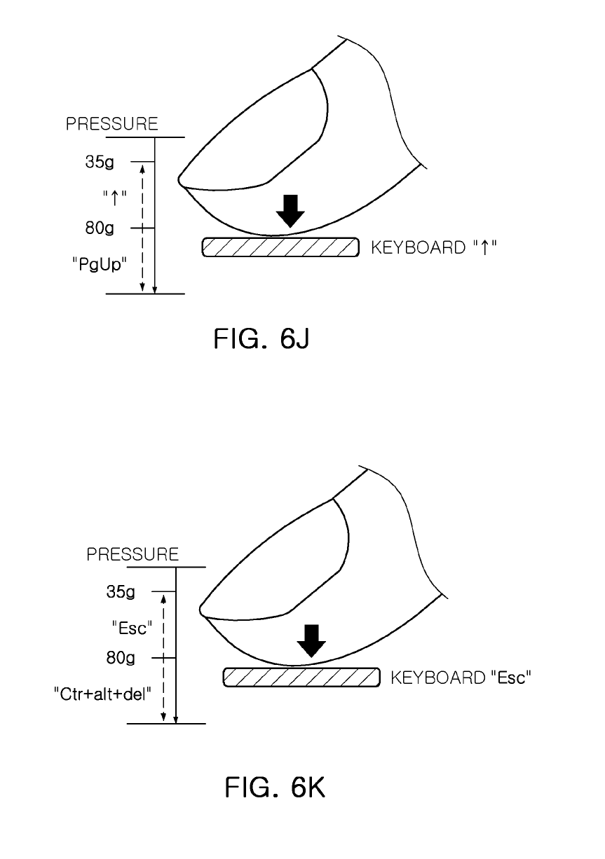

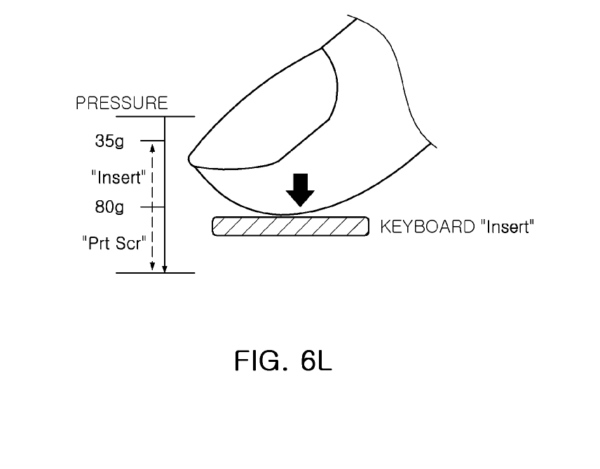

FIGS. 5A through 5L and FIGS. 6A through 6L are views showing examples of the touch interaction apparatus according to an exemplary embodiment in the present disclosure.

Referring to FIGS. 5A through 5L, the touch interaction apparatus according to an exemplary embodiment in the present disclosure or the electronic device having the same may distinguish the degree of user touch interaction through capacitance and may perform different operations according to the distinguished degree of touch interaction.

The above-mentioned different operations may mean that one of a plurality of images associated with a corresponding key is output according to the degree of touch interaction input to a touch region corresponding to a key of the input unit 110, and the plurality of images having the association may include an image displaying lower case and upper case characters, an image displaying soft consonants to hard consonants, an image displaying monophthongs to diphthongs, an image displaying a special character to shift key+special character, an image displaying a cursor by a combination of special function keys, and the like, which are provided by a combination of one key and a function key.

For example, as illustrated in FIG. 5A, outputs of upper case and lower case of characters maybe distinguished according to the degree of user touch interaction, and more particularly, in the case in which the user's touch interaction is input to a touch region corresponding to ‘a’ on a keyboard of the input unit 110, the controlling unit 120 may perform a control to output an upper case ‘A’ when a voltage level detected by the touch input is in the range of a minimum touch voltage level to 1.5V and may perform a control to output a lower case ‘a’ when the voltage level is in the range of 1.5V to 3V. In the case in which the detected voltage is formed in reverse, proportional to a touch interaction pressure, the controlling unit 120 may perform the above-mentioned control operation, and on the contrary, in the case in which the detected voltage is formed in direct proportion to the touch interaction pressure, the controlling unit 120 may perform the control to output the lower case ‘a’ when the voltage level is in the range of the minimum touch voltage level to 1.5V and may perform the control to output the upper case ‘A’ when the voltage level is in the range of 1.5V to 3V. The above-mentioned voltage level is merely an example, and may be variously set.

That is, in the case in which the user strongly touches the touch region corresponding to ‘a’ on the same keyboard, ‘A’ may be output, and in the case in which the user weakly touches the same, ‘a’ may be output. On the contrary, in the case in which the user weakly touches the same, ‘a’ may be output, and in the case in which the user strongly touches the same, ‘A’ may be output. That is, a ‘Caps Lock’ key may be replaced according to the degree of user touch interaction.

Referring to FIG. 5B, in the case in which the user's touch interaction is input to a touch region corresponding to ‘ [symbol] ’ on a keyboard of the input unit 110, the controlling unit 120 may perform a control to output a hard consonant ‘ [symbol] ’ when a voltage level detected by the touch input is in the range of a minimum touch voltage level to 1.5V and may perform a control to output a soft consonant ‘ [symbol] ’ when the voltage level is in the range of 1.5V to 3V.

Similarly, in the case in which the detected voltage is formed in reverse proportional to a touch interaction pressure, the controlling unit 120 may perform the above-mentioned control operation, and on the contrary, in the case in which the detected voltage is formed in direct proportion to the touch interaction pressure, the controlling unit 120 may perform the control to output the soft consonant ‘ [symbol] ’ when the voltage level is in the range of the minimum touch voltage level to 1.5V and may perform the control to output the hard consonant ‘ [symbol] ’ when the voltage level is in the range of 1.5V to 3V.

Similar to the description described above, referring to FIG. 5C, in the case in which the user's touch interaction is input to a touch region corresponding to ‘ [symbol] ’ on a keyboard, the controlling unit 120 may perform a control to output a diphthong ‘ [symbol] ’ when the detected voltage level is in the range of 1.5V to 3V and may perform a control to output a monophthong ‘ [symbol] ’ when the detected voltage level is in the range of the minimum touch voltage level to 1.5V. Referring to FIG. 5D, in the case in which the user's touch interaction is input to a touch region corresponding to ‘[’ on a keyboard, the controlling unit 120 may perform a control to output a special character ‘[’ when the detected voltage level is in the range of 1.5V to 3V and may perform a control to output a special character ‘{’ generated by a combination of ‘[’ on the keyboard and a shift key when the detected voltage level is in the range of the minimum touch voltage level to 1.5V. That is, a ‘shift’ key on the keyboard may be replaced according to the degree of user touch interaction.

In addition, referring to FIG. 5E, in the case in which the user's touch interaction is input to a touch region corresponding to ‘c’ on a keyboard, the controlling unit 120 may perform a control to output the ‘c’ when the detected voltage level is in the range of 1.5V to 3V and may perform a control to perform a special function by a combination of the ‘c’ on the keyboard and a control key Ctrl, for example, the function outputting an image corresponding to an operation copying a set image or performing the operation when the detected voltage level is in the range of the minimum touch voltage level to 1.5V. Referring to FIG. 5F, in the case in which the user's touch interaction is input to a touch region corresponding to ‘space’ on a keyboard, the controlling unit 120 may perform a control to move a cursor corresponding to the ‘space’ or output an image corresponding to the movement of the cursor when the detected voltage level is in the range of 1.5V to 3V and may perform a control to output an image corresponding to a ‘tap’ key input or perform a corresponding operation when the detected voltage level is in the range of the minimum touch voltage level to 1.5V.

Referring to FIG. 5G, in the case in which the user ‘s touch interaction is input to a touch region corresponding to a ‘Korean-English’ key on a keyboard, the controlling unit 120 may perform a control to output an image corresponding to a ‘Korean-English’ key input or perform a corresponding operation when the detected voltage level is in the range of 1.5V to 3V and may perform a control to output an image corresponding to a foreign language switching key input which is preset or perform a corresponding operation when the detected voltage level is in the range of the minimum touch voltage level to 1.5V.

In addition, referring to FIG. 5H, depending on a degree of touch interaction of the user's interaction with the touch region corresponding to a direction key ‘→’ on the keyboard, one of a plurality of images associated with the corresponding key may be output, and by increasing resolution of the detected voltage level, for example, in the case in which the detected voltage level is in the range of 2.5V to 3V, a movement of a cursor by the direction key ‘→’ on the keyboard may be very slowly output, in the case in which the detected voltage level is in the range of 2V to 2.5V, the movement of the cursor by the direction key ‘→’ on the keyboard may be slowly output, in the case in which the detected voltage level is in the range of 1.5V to 2V, the movement of the cursor by the direction key ‘→’ on the keyboard may be output at a regular speed, in the case in which the detected voltage level is in the range of 1V to 1.5V, the movement of the cursor by the direction key ‘→’ on the keyboard may be quickly output, and in the case in which the detected voltage level is in the range of the minimum touch voltage level to 1V, the movement of the cursor by the direction key ‘→’ on the keyboard may be very quickly output.

That is, in the case in which the direction key ‘→’ on the keyboard is weakly touched in a touch interaction, the movement of the cursor may be slowly output and in the case in which the direction key ‘→’ on the keyboard is firmly touched in a touch interaction, the movement of the cursor maybe quickly output, and vice versa. In addition, the setting of the direction key on the keyboard as described above may be applied to up, down, left, and right direction keys.

Meanwhile, the up, down, left, and right direction keys on the keyboard may output one of the movement of the cursor and the special function of the keyboard according to the degree of touch interaction of the user's interaction with the corresponding touch region.

Referring to FIG. 5I, depending on a degree of touch interaction of the user's interaction with the touch region corresponding to a direction key ‘←’ on the keyboard, the controlling unit 120 may perform a control to output an image corresponding to a direction key ‘←’ input or perform a corresponding operation when the detected voltage level is in the range of 1.5V to 3V and may perform a control to output an image corresponding to a ‘Home’ key input or perform a corresponding operation when the detected voltage level is in the range of the minimum touch voltage level to 1.5V.

In addition, referring to FIG. 5J, depending on a degree of touch interaction of the user's interaction with the touch regions corresponding to the up and down direction keys on the keyboard, the controlling unit 120 may perform a control to output an image corresponding to the up and down direction keys input or perform a corresponding operation when the detected voltage level is in the range of 1.5V to 3V and may perform a control to output an image corresponding to a ‘PgUp’ key input or perform a corresponding operation when the detected voltage level is in the range of the minimum touch voltage level to 1.5V.

Although not shown, depending on a degree of touch interaction of the user's interaction with the touch regions corresponding to the direction key ‘→’ on the keyboard, the controlling unit 120 may perform a control to output an image corresponding to the direction key ‘→’ input or perform a corresponding operation when the detected voltage level is in the range of 1.5V to 3V and may perform a control to output an image corresponding to a ‘End’ key input or perform a corresponding operation when the detected voltage level is in the range of the minimum touch voltage level to 1.5V. Depending on a degree of touch interaction of the user's interaction with the touch regions corresponding to the down direction key on the keyboard, the controlling unit 120 may perform a control to output an image corresponding to a down direction key input or perform a corresponding operation when the detected voltage level is in the range of 1.5V to 3V and may perform a control to output an image corresponding to a ‘PgDn’ key input or perform a corresponding operation when the detected voltage level is in the range of the minimum touch voltage level to 1.5V.

Referring to FIG. 5K, depending on a degree of touch interaction of the user's interaction with the touch regions corresponding to an ‘Esc’ key on the keyboard, the controlling unit 120 may perform a control to output an image corresponding to an ‘Esc’ key input or perform a corresponding operation when the detected voltage level is in the range of 1.5V to 3V and may perform a control to output an image corresponding to a ‘Ctrl’+‘Alt’+‘Del’ key combination input or perform a corresponding operation when the detected voltage level is in the range of the minimum touch voltage level to 1.5V.

In addition, referring to FIG. 5L, depending on a degree of touch interaction of the user's interaction with the touch regions corresponding to an ‘Insert’ key on the keyboard, the controlling unit 120 may perform a control to output an image corresponding to the ‘Insert’ key input or perform a corresponding operation when the detected voltage level is in the range of 1.5V to 3V and may perform a control to output an image corresponding to a ‘PrtScr’ key input or perform a corresponding operation when the detected voltage level is in the range of the minimum touch voltage level to 1.5V.

Referring to FIGS. 6A through 6L, the pressure applied according to the degree of touch interaction of the user's interaction with the corresponding touch region may be detected, and a sensitive pressure sensor may be used to measure the applied pressure by measuring a resistance value of a resistor changed according to the applied pressure.

Comparing FIGS. 5A through 5L as described above to FIGS. 6A through 6L, for example, the detected voltage level of 1.5V may correspond to a detected pressure of 80 g and the detected voltage level of 3V may correspond to a detected pressure of 35 g.

In addition, comparing FIG. 5H to FIG. 6H, the detected voltage level of 1V may correspond to a detected pressure of 100 g, the detected voltage level of 1.5V may correspond to a detected pressure of 80 g, the detected voltage level of 2V may correspond to a detected pressure of 65 g, the detected voltage level of 2.5V may correspond to a detected pressure of 50 g, and the detected voltage level of 3V may correspond to a detected pressure of 35 g.

Since a description in connection with the drawings illustrated in FIGS. 6A through 6L is the same as the description in connection with FIGS. 5A through 5L as described above except for correspondence between pressure and voltage described above, a detailed description thereof will be omitted.

As described above, according to exemplary embodiments of the present disclosure, key manipulation or a user interfacing may be efficiently implemented by providing the preset different images by one key according to the degree of touch interaction.

As set forth above, according to exemplary embodiments of the present disclosure, the key manipulation or a user interfacing may be efficiently performed.

While exemplary embodiments have been shown and described above, it will be apparent to those skilled in the art that modifications and variations could be made without departing from the spirit and scope of the present disclosure as defined by the appended claims.

What is claimed is:

1. A touch interaction apparatus comprising:
an input unit including a plurality of keys in touch regions and receiving a user's touch interaction in a touch region corresponding to one of the plurality of keys; and
a controlling unit outputting one of a plurality of images associated with the one of the plurality of keys based on a degree of the touch interaction input to the touch region corresponding to the one of the plurality of keys in the input unit.

2. The touch interaction apparatus of claim 1, wherein the controlling unit outputs one of the plurality of images according to capacitance varied by the degree of touch interaction pressure.

3. The touch interaction apparatus of claim 1, wherein the controlling unit outputs one of the plurality of images according to a pressure varied by the degree of touch interaction pressure.

4. The touch interaction apparatus of claim 1, wherein the controlling unit outputs one of the plurality of preset images according to the degree of touch interaction input to a corresponding touch region corresponding to one key.

5. The touch interaction apparatus of claim 4, wherein the controlling unit outputs an image from a from a group of images including at least one group of an upper case and lower case character function, a number and symbol function, a soft consonant, hard consonant, and aspirated consonant function, a monophthong and diphthong function, a cursor movement by a space bar and a tab key, cursor movements in up, down, left, and right directions, an function of a plurality of special characters, and an function of a plurality of function keys, according to the degree of touch interaction input to the corresponding touch region corresponding to one key.

6. An electronic device comprising:
a touch interaction apparatus having an input unit including a plurality of keys formed in preset touch regions and receiving a user's touch interaction in a corresponding touch region of each of the plurality of keys and a controlling unit outputting one of a plurality of images associated with a corresponding key according to a degree of touch interaction input to a touch region corresponding to a key of the input unit; and
a display unit displaying an image from the touch interaction apparatus.

7. The electronic device of claim 6, wherein the controlling unit outputs one of the plurality of images according to capacitance varied by the degree of touch interaction pressure.

8. The electronic device of claim 6, wherein the controlling unit outputs one of the plurality of images according to a pressure varied by the degree of touch interaction pressure.

9. The electronic device of claim 6, wherein the controlling unit outputs one of the plurality of images according to the degree of touch interaction input to a corresponding touch region corresponding to one key.

10. The electronic device of claim 9, wherein the controlling unit outputs an image from a from a group of images including at least one group of an upper case and lower case character function, a number and symbol function, a soft consonant, hard consonant, and aspirated consonant function, a monophthong and diphthong function, a cursor movement by a space bar and a tab key, cursor movements in up, down, left, and right directions, a function of a plurality of special characters, and a function of a plurality of function keys, according to the degree of touch interaction input to the corresponding touch region corresponding to one key.
